(19) United States
(12) Patent Application Publication
(10) Pub. No.: US 2017/0003128 A1
(43) Pub. Date: Jan. 5, 2017

(54) INFORMATION PROCESSING SYSTEM, INFORMATION PROCESSING METHOD, AND MOVABLE TERMINAL DEVICE

(71) Applicant: FUJITSU LIMITED, Kawasaki-shi (JP)

(72) Inventor: Taki KONO, Kodaira (JP)

(73) Assignee: FUJITSU LIMITED, Kawasaki-shi (JP)

(21) Appl. No.: 15/266,361

(22) Filed: Sep. 15, 2016

Related U.S. Application Data
(63) Continuation of application No. PCT/JP2014/059596, filed on Mar. 31, 2014.

(51) Int. Cl. G01C 13/00

(52) U.S. Cl. CPC G01C 13/002; G08G 3/02

(57) ABSTRACT

An information processing system includes: a plurality of movable terminal devices; a plurality of base stations; and an information processing device. The plurality of movable terminal devices are provided in vessels, and the plurality of movable terminal devices include: a first processor that executes a first process including: acquiring positional information on a movement start position of the vessel and a direction of a bow, a rudder angle, and a vessel speed of the vessel during movement; calculating a predicted position of the vessel in accordance with the positional information on the movement start position, the direction of the bow, the rudder angle, and the vessel speed; specifying a direction and a magnitude of a tidal current in accordance with a difference between current positional information on the vessel and the predicted position; and transmitting, to the plurality of base stations, management information.

### CROSS-REFERENCE TO RELATED APPLICATION

This application is a continuation application of International Application No. PCT/JP2014/059596, filed on Mar. 31, 2014 and designating the U.S., the entire contents of which are incorporated herein by reference.

### FIELD

The embodiments discussed herein are related to an information processing system, an information processing method, an information processing program, and a movable terminal device.

### BACKGROUND

Conventionally, in order to collect marine phenomenon data on ocean currents, tidal currents, or the like, the marine phenomenon data is observed by a plurality of observation units, provided on a predetermined ocean area, and is collected by a base station. Furthermore, it is disclosed that the information from the gyrocompass and the vessel speed meter of a vessel and the GPS (Global Positioning System) information are received from a plurality of vessels, and an ocean current is predicted based on these pieces of information.

Patent Document 1: Japanese Laid-open Patent Publication No. 2010-223639

Patent Document 2: Japanese Laid-open Patent Publication No. 2014-013145

Patent Document 3: Japanese Laid-open Patent Publication No. 2002-267769

Patent Document 4: Japanese Laid-open Patent Publication No. 2005-189165

However, if the ocean current is predicted based on the information from the gyrocompass and the vessel speed meter and the GPS information, the amount of movement of a vessel is calculated in accordance with the direction and the speed of the actual movement of the vessel; therefore, no consideration is given to the amount of drift in a case where it is subjected to the ocean current or the tidal current from the side. Thus, as it is difficult to observe the ocean current or the tidal current that is different from the moving direction of the vessel, degradation sometimes occurs in the accuracy with which the ocean current or the tidal current is observed.

### SUMMARY

According to an aspect of the embodiments, an information processing system includes: a plurality of movable terminal devices; a plurality of base stations; and an information processing device. The plurality of movable terminal devices are provided in vessels, and the plurality of movable terminal devices include: a first processor that executes a first process including: acquiring positional information on a movement start position of the vessel and a direction of a bow, a rudder angle, and a vessel speed of the vessel during movement; calculating a predicted position of the vessel in accordance with the positional information on the movement start position, the direction of the bow, the rudder angle, and the vessel speed; specifying a direction and a magnitude of a tidal current in accordance with a difference between current positional information on the vessel and the predicted position; and transmitting, to the plurality of base stations, management information that includes the direction and the magnitude of the tidal current specified, positional information before and after movement of the vessel, and identification information on the movable terminal device. The plurality of base stations include a second processor that executes a second process including receiving the management information, transmitted from the movable terminal device, and transmitting the management information to the information processing device. The information processing device includes: a third processor that executes a third process including: receiving the management information from a base station, which has received the management information, among the plurality of base stations; and generating tidal current information that includes a distribution of a tidal current on an ocean area where each of the vessels sails in accordance with a direction and a magnitude of a tidal current for each of the vessels, positional information before and after movement of each of the vessels, and identification information on each of the plurality of movable terminal devices, included in the management information received.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram that illustrates an example of the configuration of an information processing system according to the embodiment;

FIG. 2 is an explanatory diagram that illustrates an example of the relationship among the moving direction of the vessel, the tidal current, and the rudder angle;

FIG. 3 is an explanatory diagram that illustrates an example of the relationship among the moving direction of the vessel, the direction of the bow, and the rudder angle;

FIG. 4 is an explanatory diagram that illustrates an example of the relationship between the predicted position and the present position;

FIG. 5 is an explanatory diagram that illustrates an example of the message format;

FIG. 6 is an explanatory diagram that illustrates an example of a management-information storage unit;

FIG. 7 is an explanatory diagram that illustrates an example of a tidal-current data storage unit;

FIG. 8 is an explanatory diagram that illustrates an example of presentation of tidal current information;

FIG. 9 is a sequence diagram that illustrates an example of the operation of the information processing system according to the embodiment; and

FIG. 10 is an explanatory diagram that illustrates an example of a computer that executes an information processing program.

### DESCRIPTION OF EMBODIMENTS

Preferred embodiments will be explained with reference to accompanying drawings. Here, the present embodiment is not a limitation on the disclosed technology. Furthermore, the following embodiments may be combined as appropriate within the range where there are no contradictions.

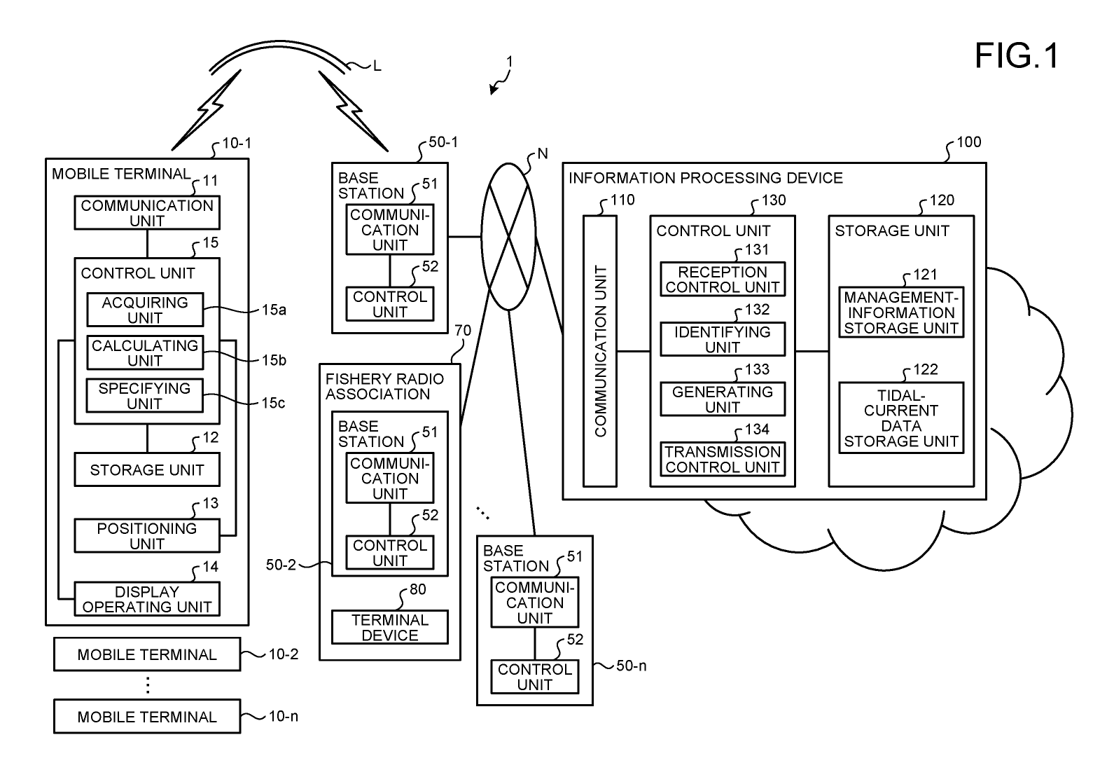

FIG. 1 is a block diagram that illustrates an example of the configuration of an information processing system according to the embodiment. An information processing system 1, illustrated in FIG. 1, includes a plurality of mobile terminals 10, a plurality of base stations 50, a terminal device 80, and an information processing device 100.

The mobile terminals 10 and the base stations 50 are communicatively connected to each other via radio waves in shortwave bands by using reflection of an ionosphere L. Furthermore, the base stations 50, the terminal device 80, and the information processing device 100 are communicatively connected to one another via a network N. The network N may be wired or wireless, and any type of communication networks, such as a LAN (Local Area Network) or a VPN (Virtual Private Network), as well as the Internet may be used.

Here, the information processing system 1 is explained. In the following explanations, an explanation is given of a case where a fishing vessel is an example of the vessel. In the information processing system 1, for example, the mobile terminals 10 (illustrated as mobile terminals 10-1, 10-2, . . . , 10-n) are provided in fishing vessels that are in operation in distant seas, e.g., at an ocean area away from the seacoast by equal to or more than 200 nautical miles. Furthermore, in the information processing system 1, for example, the base station 50 and the terminal device 80 are provided in a fishery radio association 70 that is located near a fishing harbor. Furthermore, in the information processing system 1, for example, the information processing device 100 is provided in a cloud, such as a data center, and is connected to each of the base stations 50 and the terminal device 80 via the network N. Moreover, in the example of FIG. 1, a base station 50-1 is provided in, for example, Hokkaido, a base station 50-2 is provided in, for example, Okinawa, and another one of the base stations 50 is a base station 50-n. Here, FIG. 1 illustrates a case where the number of the fishery radio association 70 is 1 for simplification and the base station 50-2 and the terminal device 80 are provided within the fishery radio association 70; however, this is not a limitation. The base station 50 may be installed alone or may be provided within the different fishery radio association 70. Similarly, the terminal device 80 is provided within the different fishery radio association 70 as the terminal device 80 of the fishery radio association 70.

Each fishing vessel, in which the mobile terminal 10 is provided, transmits for example the management information that includes the tidal current data, observed by the vessel itself, the positional information before and after movement, and the identification information on the mobile terminal 10 to any one or more of the base stations 50 by using a wireless device in shortwave bands. Here, the tidal current data includes the direction and the magnitude of the tidal current, the positional information before and after movement, and the identification information. Furthermore, the tidal current data may include the time when the tidal current data is specified or the time when data is detected to calculate the tidal current data. The radio waves, transmitted from the mobile terminal 10, are reflected by the ionosphere L and reach any one or more of the base stations 50 out of the base stations 50 that are located outside the line-of-sight distance. When the base station 50, at which the radio waves arrive, receives the radio waves, transmitted from the mobile terminal 10, and acquires the management information, it transmits the acquired management information to the information processing device 100 via the network N. Here, for example, the radio waves, transmitted from the mobile terminal 10, are received by the base station 50 of the fishery radio association 70, which is different from the fishery radio association 70 to which the fishing vessel with the mobile terminal 10 installed therein belongs.

Upon reception of the management information, the information processing device 100 determines the identification information on the mobile terminal 10, i.e., the identification information on the fishing vessel with the mobile terminal 10 installed therein, from the management information. The information processing device 100 relates the tidal current data, the positional information, and the identification information, included in the management information, and stores them in a tidal-current data storage unit 122 that is described later. Furthermore, the information processing device 100 refers to a management-information storage unit 121, which is described later, and transmits the management information to the terminal device 80 that is provided in the fishery radio association 70 to which the fishing vessel belongs. The information processing device 100 stores the tidal current data, transmitted from the mobile terminals 10 that are provided in a plurality of fishing vessels, in the tidal-current data storage unit 122 and, based on the tidal current data, generates the tidal current information that includes the distribution of the tidal current. The information processing device 100 transmits the generated tidal current information to the vessels that sail on the corresponding ocean area, i.e., the vessels that include the fishing vessel which has transmitted the tidal current data, via the network N and the base stations 50. Thus, the information processing device 100 is capable of generating tidal current information that includes the distribution of the tidal current at a certain ocean area based on the tidal current data that is collected by individual vessel (fishing vessel) that sails on the ocean area.

Next, an explanation is given of each component that is included in the information processing system 1. The mobile terminal 10 includes a communication unit 11, a storage unit 12, a positioning unit 13, a display operating unit 14, and a control unit 15. Furthermore, the mobile terminal 10 may include various functional units that are included in already-known computers, e.g., functional units such as various input devices or sound output devices, other than the functional units that are illustrated in FIG. 1. Tablet terminals, portable personal computers, or the like, may be used as an example of the mobile terminal 10. Here, the mobile terminal 10 is a transmitter that transmits the management information by using short waves. Furthermore, in the following explanations, if each of the mobile terminals 10-1, 10-2, or the like, is not distinguished, they are simply represented as the mobile terminal 10. Furthermore, the mobile terminal 10 is a movable terminal device.

For example, the communication unit 11 is implemented by a wireless device, or the like, in middle-wave to short-wave bands. The communication unit 11 is a communication interface that is wirelessly connected to any one or more of the base stations 50 via the ionosphere L and that communicates information with the information processing device 100 via the base station 50 and the network N. The communication unit 11 transmits the management information, input from the control unit 15, to the base station 50. Furthermore, the communication unit 11 receives the radio waves, transmitted from the base station 50, and acquires various types of information, such as the tidal current information.

The communication unit 11 may use one or more frequency bands out of, for example, 2 MHz band, 4 MHz band, 8 MHz band, 12 MHz band, and 16 MHz band, as the radio waves in the middle-wave to short-wave bands. For example, the communication unit 11 uses the frequency band that is selected by the operator of the mobile terminal 10 in accordance with the distance from the land and the time of day. This is because the propagation state of radio waves in middle-wave and short-wave bands is affected by the ionosphere whose state is changed due to the solar activity and the time of day or night. Furthermore, selection of the frequency may be such that, based on the positional information that is acquired during positioning by the positioning unit 13, the distance to the representative base station 50 is calculated, each frequency is weighted in accordance with the calculated distance, the season, and the time, and the frequency, which is more likely to reach, is selected. Furthermore, the frequency is selected in consideration of the band characteristics of each frequency band.

The communication unit 11 may use, as a modulation method, digital modulation, such as PSK (Phase Shift Keying) or FSK (Frequency Shift Keying). Furthermore, the communication unit 11 may use a modulation method, such as PSK31, in a low frequency band. For example, the communication rate of PSK31 is low, i.e., 31 baud; however, as its occupied band is narrow, it is suitable for data communication in shortwave bands principally to communicate text data. Furthermore, as a method for connection with the control unit 15, the communication unit 11 may input/output modulation signals by using for example the serial communication that uses RS-232C for the control of the communication unit 11 and by using the sound input/output terminal for transaction of data, such as the management information.

The storage unit 12 is implemented by a semiconductor memory device, such as a RAM (Random Access Memory) or a flash memory, or a storage device, such as a hard disk or an optical disk. The storage unit 12 temporarily stores the direction and the magnitude of the tidal current, the positional information before and after movement, and the identification information, which are included as the tidal current data in the management information. Furthermore, the storage unit 12 temporarily stores the direction of the bow of the fishing vessel with the mobile terminal 10 installed therein, the rudder angle, and the vessel speed. Moreover, the storage unit 12 stores various different types of information, the information that is used for operations of the control unit 15, or the like.

The positioning unit 13 receives signals from the satellite positioning system. The positioning unit 13 conducts positioning by receiving signals from the global satellite navigation system, such as the GPS (Global Positioning System), GLONASS (Global Navigation Satellite System), Galileo, or compass, as a satellite positioning system. If the control unit 15 requests positioning, the positioning unit 13 conducts positioning and outputs a positioning result as the positional information based on a geodetic system, such as WGS (World Geodetic System) 84. Furthermore, if the control unit 15 requests continuous positioning, the positioning unit 13 continuously conducts positioning and outputs the positional information continuously until the control unit 15 requests to stop it. Furthermore, the positioning unit 13 may receive signals from, as a satellite positioning system, the Quasi-Zenith Satellite System, Indian Regional Navigational Satellite System, DORIS (Doppler Orbitography and Radio-positioning Integrated by Satellite), or a regional navigation satellite system, e.g., BeiDou.

The display operating unit 14 is a display device to display various types of information and an input device to receive various operations from a user. For example, the display operating unit 14 is implemented by a liquid crystal display, or the like, as the display device. Furthermore, for example, the display operating unit 14 is implemented by a touch panel, or the like, as the input device. That is, the display operating unit 14 is an integration of the display device and the input device. Furthermore, as a user interface, the display operating unit 14 for example displays a keyboard on a lower section of the screen and receives key input. The display operating unit 14 outputs an operation, input by a user, as the operation information to the control unit 15. Furthermore, the display operating unit 14 displays the tidal current information, or the like, input from the control unit 15.

The control unit 15 is implemented when, for example, a CPU (Central Processing Unit), a MPU (Micro Processing Unit), or the like, executes a program, stored in an internal storage device, with the RAM as a work area. Furthermore, the control unit 15 may be implemented by an integrated circuit, such as an ASIC (Application Specific Integrated Circuit) or an FPGA (Field Programmable Gate Array). The control unit 15 includes an acquiring unit 15a, a calculating unit 15b, and a specifying unit 15c. Furthermore, the control unit 15 performs overall control of the mobile terminal 10. Furthermore, for example, the control unit 15 may acquire the positional information from the positioning unit 13 more than three times a day for the deemed GMDSS and may transmit the management information that includes the acquired positional information to the base station 50 via the communication unit 11. Here, in this case, the management information may include the tidal current data or does not need to include it.

After a fishing vessel starts to move, the acquiring unit 15a outputs, to the positioning unit 13, a request to continuously conduct positioning. When the acquiring unit 15a receives input of the positional information, which corresponds to the positioning request, from the positioning unit 13, it acquires the first input positional information as the positional information on the movement start position.

Furthermore, after a fishing vessel starts to move, the acquiring unit 15a starts to acquire the direction of the bow from an undepicted orientation sensor, gyrocompass, or the like. Here, the direction of the bow may be acquired from a navigation device of the fishing vessel. Furthermore, the acquiring unit 15a starts to acquire the rudder angle and the rotating speed of the engine from an undepicted fishing vessel's navigation device. The acquiring unit 15a calculates the vessel speed based on the rotating speed of the engine. Here, instead of the rotating speed of the engine, the acquiring unit 15a may acquire the speed that is measured by a vessel speed meter that is electromagnetic, acoustic, or the like.

The acquiring unit 15a outputs, to the calculating unit 15b, the acquired positional information on the movement start position and the direction of the bow, the rudder angle, and the vessel speed during movement of the fishing vessel, for which acquisition has been started. The acquiring unit 15a outputs the positional information on the movement start position to the specifying unit 15c. Furthermore, the acquiring unit 15a starts to output, to the specifying unit 15c, the positional information, which is acquired during movement of the fishing vessel, as the current positional information. Moreover, the acquiring unit 15a may store, in the storage unit 12, the acquired positional information on the movement start position and the direction of the bow, the rudder angle, and the vessel speed during movement of the fishing vessel, for which acquisition has been started.

After the calculating unit 15b receives inputs of the acquired positional information on the movement start position and the direction of the bow, the rudder angle, and the vessel speed during movement of the fishing vessel, for which acquisition has been started, it calculates the predicted position of the fishing vessel based on the above information. For example, the calculating unit 15b calculates the predicted position in accordance with an elapsed time by using the movement start position as a reference based on the direction of the bow, the rudder angle, and the vessel speed. The calculating unit 15b outputs the predicted position to the specifying unit 15c.

The specifying unit 15c receives input of the current positional information from the acquiring unit 15a and receives input of the predicted position from the calculating unit 15b. The specifying unit 15c determines whether calculation of the predicted position is to be continued based on the current positional information and the predicted information. If calculation of the predicted position is to be continued, the specifying unit 15c gives a command to continue it to the acquiring unit 15a and the calculating unit 15b. If calculation of the predicted position is not to be continued, the specifying unit 15c acquires the input current positional information as the positional information on the present position. That is, the specifying unit 15c detects the arrival position at which the vessel arrives. The specifying unit 15c specifies the direction and the magnitude of the tidal current based on the difference between the positional information on the present position and the predicted position. The specifying unit 15c specifies the direction and the magnitude of the tidal current, for example, every 10 seconds. Here, the specifying unit 15c may specify the direction and the magnitude of the tidal current at any time interval, for example, a unit of more than 1 second, e.g., every 5 minutes or 10 minutes.

Furthermore, the specifying unit 15c combines the present position and the positional information on the movement start position, input from the acquiring unit 15a, as the positional information before movement to obtain the positional information before and after movement. The specifying unit 15c generates, as the tidal current data, the specified direction and magnitude of the tidal current and the positional information before and after movement. Furthermore, the specifying unit 15c generates the management information that includes the tidal current data and the identification information that is previously set in the control unit 15. Here, the generated management information is compatible with the message format that is described later. Although the message format, described later, does not indicate an area to which the tidal current data, or the like, is inserted, it may be provided with an optional area. The specifying unit 15c transmits the generated management information to the base stations 50 via the communication unit 11.

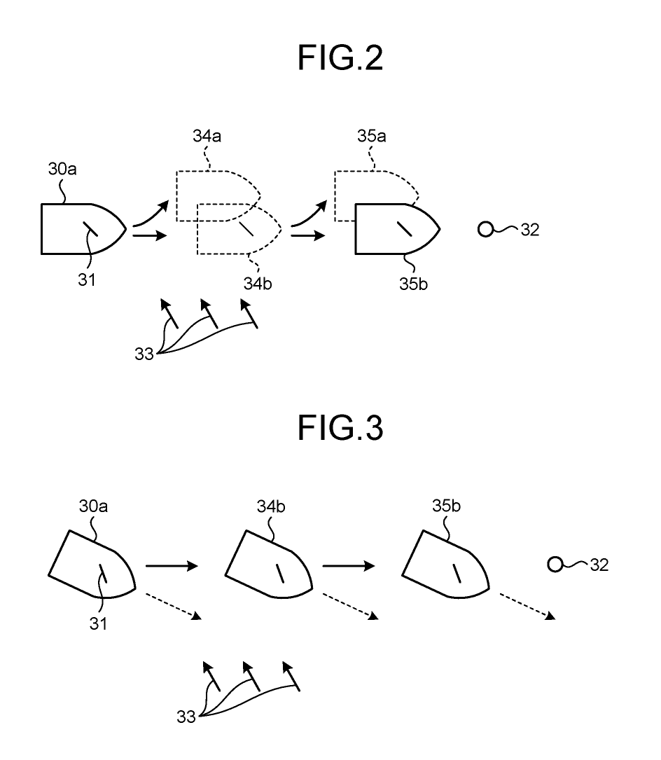

Here, an explanation is given of the relationship among the moving direction of the fishing vessel, the tidal current, and the rudder angle. FIG. 2 is an explanatory diagram that illustrates an example of the relationship among the moving direction of the vessel, the tidal current, and the rudder angle. As illustrated in FIG. 2, it is assumed that a fishing vessel 30a heads for a target point 32 with a rudder angle 31 and at a predetermined speed. Here, it is assumed that the direction of the bow of the fishing vessel 30a before the start of movement is in the direction to the target point 32. After the fishing vessel 30a starts to move to the target point 32, it travels with the helm at the rudder angle 31 as it is drifted by a tidal current 33. Here, if the rudder angle of the fishing vessel 30a is zero, i.e., it is in the direction of the bow, it is drifted by the tidal current 33 and is moved to a position 34a. However, as the fishing vessel 30a takes the helm at the rudder angle 31, i.e., in the direction from which the tidal current 33 flows, it moves to a position 34b on the line that connects the movement start position and the target point 32 without being drifted. During movement from the position 34b to a position 35b, the fishing vessel 30a also moves by taking the helm at the rudder angle 31 so as not to be drifted to a position 35a. That is, the fishing vessel 30a takes the rudder angle 31 in accordance with the tidal current 33 so as to reach the target point 32 without being drifted.

A more detailed explanation is given of the above-described example from a viewpoint of the fishing vessel 30a. FIG. 3 is an explanatory diagram that illustrates an example of the relationship among the moving direction of the vessel, the direction of the bow, and the rudder angle. As illustrated in FIG. 3, after the fishing vessel 30a starts to move, its bow faces the direction of the arrow by the dotted line of FIG. 3 in accordance with the rudder angle 31; however, as it is drifted by the tidal current 33, it is actually moved in a direction, i.e., in the direction of the arrow by the solid line of FIG. 3, and reaches the position 34b. As the fishing vessel 30a also moves by taking the helm with the rudder angle 31 at the position 34b, it reaches the position 35b. In this way, the fishing vessel 30a moves in a state where the direction of the bow does not match the moving direction.

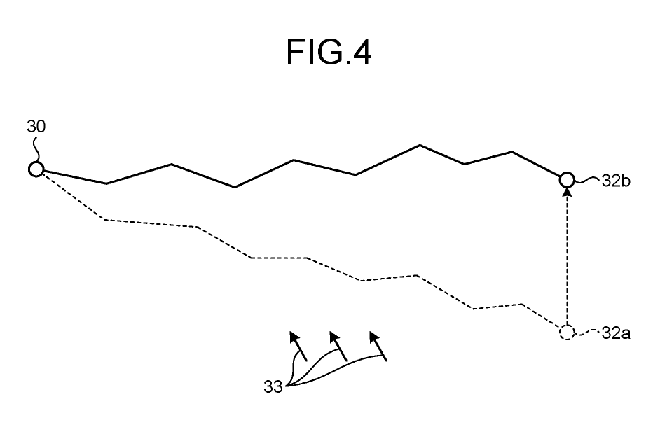

Next, an explanation is given of the gap between the predicted position, which is predicted based on the direction of the bow, the rudder angle, and the vessel speed, and the present position, which is measured by using, for example, the GPS. FIG. 4 is an explanatory diagram that illustrates an example of the relationship between the predicted position and the present position. As illustrated in FIG. 4, after the fishing vessel 30a starts to move from a movement start position 30 toward the target point 32 in FIG. 2, it follows the track, indicated by the solid line, due to the rudder angle 31 by the steerer of the fishing vessel 30a and the tidal current 33, and it moves to a present position 32b after movement. Conversely, the predicted position, which is predicted based on the direction of the bow, the rudder angle, and the vessel speed, is a predicted position 32a as it is not affected by the tidal current 33. The specifying unit 15c specifies the direction and the magnitude of the tidal current 33 based on the difference between the predicted position 32a and the present position 32b.

Furthermore, the control unit 15 also requests the positioning unit 13 to conduct positioning so as to acquire the positional information, which is included in the management information, during communications at the fixed time for the deemed GMDSS, or when request information is received. The control unit 15 outputs, as a positioning request, any one of a request for one-time-only positioning and a request for continuous positioning to the positioning unit 13. When the control unit 15 receives input of the positional information in response to the positioning request from the positioning unit 13, it inserts the positional information into the message format to generate the message, which is the management information. The control unit 15 outputs the generated message, i.e., the management information, to the communication unit 11. Furthermore, the control unit 15 may code part of the positional information such that it may be decoded by only the terminal device 80 in the fishery radio association 70 to which the fishing vessel with the mobile terminal 10 installed therein belongs.

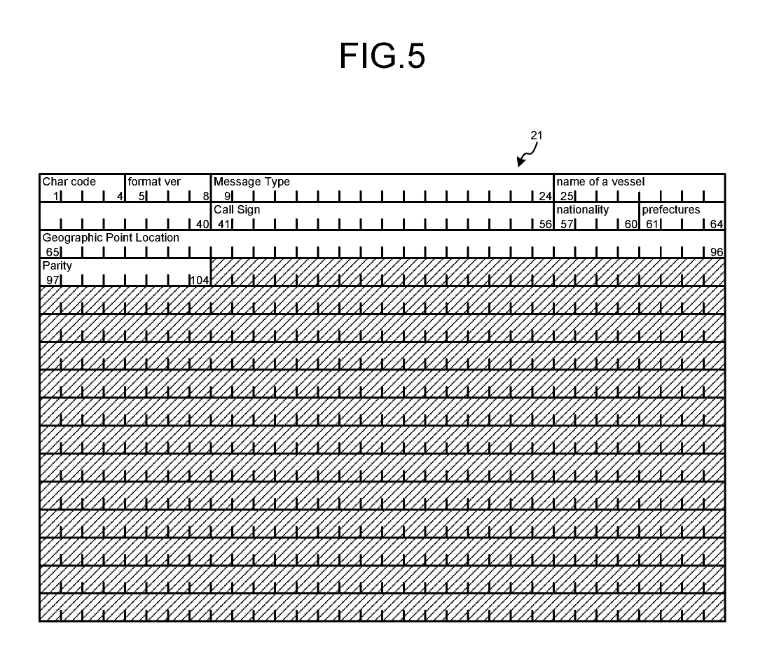

FIG. 5 is an explanatory diagram that illustrates an example of the message format. As illustrated in FIG. 5, a message format 21 contains items, such as “Char code”, “format ver”, “Message Type”, “name of a vessel”, “Call Sign”, “nationality”, “prefectures”, “Geographic Point Location”, and “Parity”. Furthermore, in the message format 21 of FIG. 2, for example, 1 cell is 1 byte. Furthermore, the length of the message format 21, illustrated in FIG. 2, is for example 104 bytes; however, this is not a limitation, and it may have any length. Moreover, the message format 21 may include items, such as the codes of other radio associations for forwarding, the positional-information mask level that indicates the level for masking part of the positional information, i.e., coding, or the tidal current data.

The “Char code” indicates a character code scheme. The “format ver” indicates the version of the message format 21, and it is the item to deal with a change in the format. The “Message Type” indicates the type of message, and it indicates the type of message, such as automatic, manual, request transmission, or emergency. The “name of a vessel” indicates the vessel name or the identification information on the fishing vessel with the mobile terminal 10 installed therein. Furthermore, if there is space for the number of characters, “name of a vessel” may indicate both the vessel name and the identification information on the fishing vessel. The “Call Sign” indicates the call sign of a wireless station for ensuring the identification. The “nationality” is an abbreviation for “nationality registration”, and it indicates the vessel nationality code. The “prefectures” indicates the local prefectural government to which it belongs. The “Geographic Point Location” indicates the positional information, and it indicates, for example, the positioning system, the latitude, and the longitude. The “Parity” is parity for checking whether a message is completely received.

Furthermore, for example, when the control unit 15 receives the tidal current information from the base station 50, it maps the tidal current information on, for example, the marine chart and causes the display operating unit 14 to display it. Furthermore, the control unit 15 may cause the display operating unit 14 to display other various types of information, such as weather information or market information on fishery products.

With reference back to FIG. 1, the base station 50 includes a communication unit 51 and a control unit 52. Fr example, the base station 50 includes a wireless device for each frequency band, and the wireless devices are connected to respective undepicted antennas and are capable of simultaneously communicating with the mobile terminals 10, provided in a plurality of fishing vessels, at the respective frequency bands.

The communication unit 51 is implemented by, for example, a wireless device in middle-wave to short-wave bands. Furthermore, the communication unit 51 is implemented by, for example, an NIC (Network Interface Card) so as to communicate with the information processing device 100 via the network N. The communication unit 51 is wirelessly connected to any one or more of the mobile terminals 10 via the ionosphere L and is connected to the information processing device 100 via the network N. Specifically, the communication unit 51 is a communication interface that communicates information between the mobile terminal 10 and the base station 50 and between the base station 50 and the information processing device 100. That is, the base station 50 relays communication between the mobile terminal 10 and the information processing device 100. The communication unit 51 connects to the network N wired or wirelessly.

As a wireless device in middle-wave to short-wave bands, for example, the communication unit 51 uses a plurality of wireless device, e.g., 5 wireless devices that correspond to, for example, 2 MHz band, 4 MHz band, 8 MHz band, 12 MHz band, and 16 MHz band, to receive the radio waves that are transmitted from the mobile terminal 10. The communication unit 51 receives the radio signals, which are transmitted from the mobile terminals 10 and which use radio waves at different frequencies, by using the wireless devices at the corresponding frequencies. Furthermore, the used frequency band is determined based on any one or more of the position of the fishing vessel with the mobile terminal 10 installed therein and the time of day. Furthermore, the communication unit 51 uses, as a modulation method, the same modulation method as that of the communication unit 11 of the mobile terminal 10. Moreover, as is the case with the mobile terminal 10, the communication unit 51 may use the serial communication that uses RS-232C and the data communication that uses a sound input/output terminal for the connection with the control unit 52.

The communication unit 51 extracts the management information from the received radio waves and outputs it to the control unit 52. Furthermore, the communication unit 51 transmits the extracted management information to the information processing device 100 via the network N by using the NIC. Moreover, the communication unit 51 transmits the tidal current information, transmitted from the information processing device 100 via the network N, to the fishing vessel with the mobile terminal 10 installed therein at a predetermined time and frequency in accordance with a predetermined time table.

The control unit 52 performs overall control of the base station 50. When the control unit 52 receives input of the management information from the communication unit 51, it causes for example an undepicted display unit to display a message that the management information has been received. The control unit 52 is for example a computer for controlling the base station 50, and it may be for example a built-in computer, a stationary personal computer, or the like.

Furthermore, the control unit 52 controls the communication unit 51 so as to transmit various types of information, received from the information processing device 100, to the mobile terminal 10 by referring to the predetermined time table, stored in an undepicted storage unit.

The terminal device 80 is a computer that is provided in, for example, the fishery radio association 70, and that receives, from the information processing device 100, provision of the management information that is transmitted from the mobile terminal 10 of the fishing vessel that belongs to the fishery radio association 70. A personal computer may be used as an example of the terminal device 80. Not only the above-described stationary terminal, such as a personal computer, but also various mobile terminal devices may be used as the terminal device 80. The terminal device 80 accumulates and stores the management information, received from the information processing device 100 via the network N, in an undepicted storage unit. Furthermore, the management information here does not need to include the tidal current data. Furthermore, for example, the terminal device 80 manages the fishing vessel that belongs to the fishery radio association 70. As the management information on the fishing vessel, the terminal device 80 manages, for example, the identification information on the fishing vessel, the captain of the vessel, the departure time and date, the fishing ocean area, or the return scheduled time and date. Moreover, the terminal device 80 may transmit the port information, or the like, to the mobile terminal 10 of the fishing vessel, which belongs to the fishery radio association 70, via the information processing device 100.

The information processing device 100 includes a communication unit 110, a storage unit 120, and a control unit 130. The information processing device 100 may include various functional units that are included in already-known computers, e.g., functional units such as various input devices or sound output devices, other than the functional units that are illustrated in FIG. 1. Furthermore, the information processing device 100 may be configured on what is called a cloud to enable expansion or changes to the configuration in a flexible manner.

The communication unit 110 is implemented by for example an NIC. The communication unit 110 is a communication interface that is connected to the base station 50 via the network N wired or wirelessly and that communicates information with the base station 50. The communication unit 110 receives the management information from the base station 50. The communication unit 110 outputs the received management information to the control unit 130. Furthermore, from the control unit 130, the communication unit 110 receives input of the management information in which the identification information on the mobile terminal 10 is identified. The communication unit 110 transmits the input management information, which makes identification, to the management body that is related to the management information, i.e., the terminal device 80 of the fishery radio association 70 to which the fishing vessel with the mobile terminal 10, which has transmitted the management information, installed therein belongs to.

Furthermore, after the communication unit 110 receives input of the tidal current information from the control unit 130, it transmits the tidal current information to the base station 50 via the network N. Furthermore, after the communication unit 110 receives input of the information that includes the weather information, or the like, input from the control unit 130, it transmits the information to the base station 50 via the network N.

The storage unit 120 is implemented by a semiconductor memory device, such as a RAM or a flash memory, or a storage device, such as a hard disk or an optical disk. The storage unit 120 includes the management-information storage unit 121 and the tidal-current data storage unit 122. Furthermore, the storage unit 120 stores the information that is used during an operation of the control unit 130.

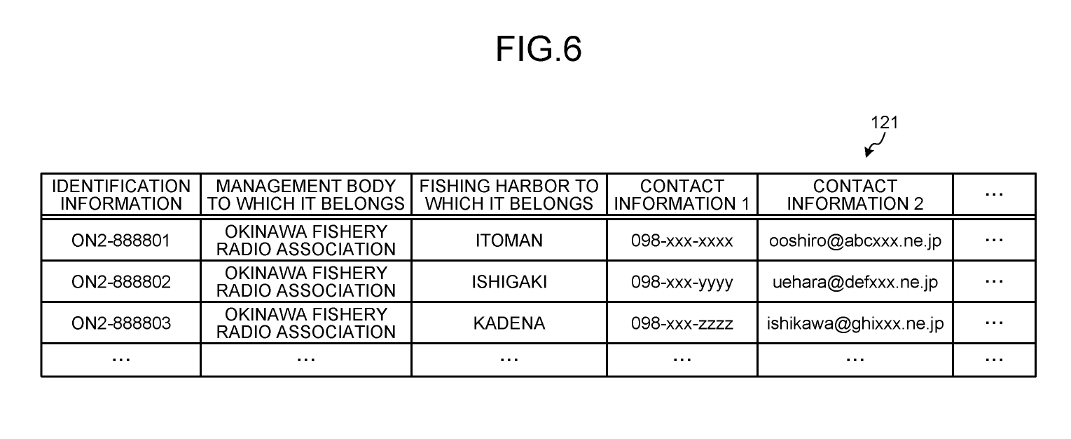

The management-information storage unit 121 stores the identification information on the fishing vessel, the management body to which it belongs, the fishing harbor to which it belongs, and the contact information in a related manner. FIG. 6 is an explanatory diagram that illustrates an example of the management-information storage unit. As illustrated in FIG. 6, the management-information storage unit 121 contains the items, such as “identification information”, “management body to which it belongs”, “fishing harbor to which it belongs”, “contact information 1”, and “contact information 2”.

The “identification information” is for example a fishing vessel registration number, and it identifies the fishing vessel. The “management body to which it belongs” indicates the management body to which the fishing vessel belongs, e.g., a fishery radio association. The “fishing harbor to which it belongs” indicates the fishing harbor to which the fishing vessel belongs. The fishing harbor to which the fishing vessel belongs corresponds to, for example, a fishery cooperative association to which the fishing vessel belongs. The “contact information 1” and “contact information 2” indicate for example the contact phone number, contact e-mail address, or the like, of the family of the captain of the fishing vessel.

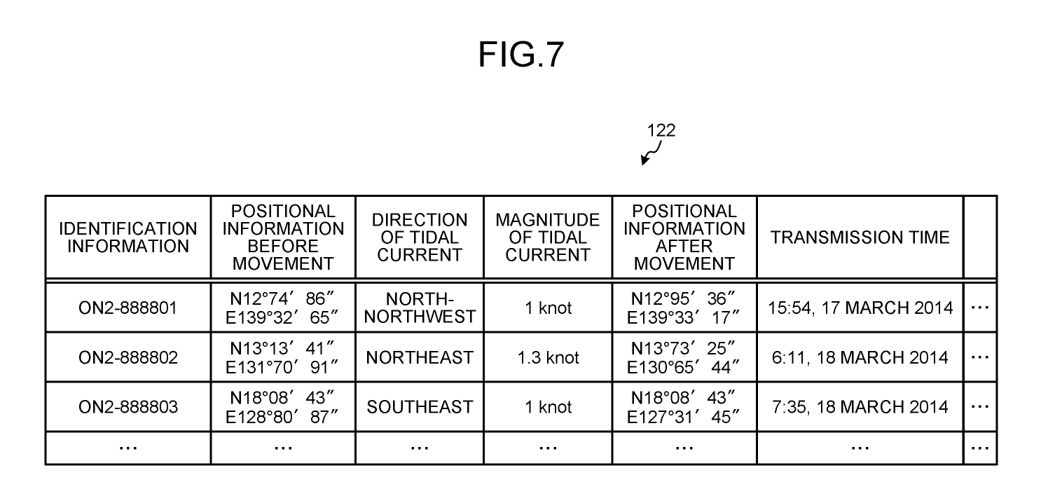

The tidal-current data storage unit 122 stores the identification information on the fishing vessel, the positional information before movement, the direction of the tidal current, the magnitude of the tidal current, the positional information after movement, and the transmission time in a related manner. FIG. 7 is an explanatory diagram that illustrates an example of the tidal-current data storage unit. As illustrated in FIG. 7, the tidal-current data storage unit 122 contains the items, such as “identification information”, “positional information before movement”, “direction of the tidal current”, “magnitude of the tidal current”, “positional information after movement”, and “transmission time”.

The “identification information” is for example a fishing vessel registration number, and it identifies the fishing vessel. The “positional information before movement” indicates for example the positional information on the movement start position of the fishing vessel. The “direction of the tidal current” indicates the direction of the tidal current, included in the tidal current data that is received from the mobile terminal 10 of each fishing vessel. The “magnitude of the tidal current” indicates the magnitude of the tidal current, included in the tidal current data that is received from the mobile terminal 10 of each fishing vessel. The “positional information after movement” indicates for example the present position with the passage of a predetermined time after the fishing vessel starts to move. The “transmission time” indicates for example the time when the mobile terminal 10 generates the management information, including the tidal current data, or the like, and transmits it to the base station 50. Here, the transmission time is embedded in the management information when the mobile terminal 10 transmits the management information.

With reference back to FIG. 1, the control unit 130 is implemented when, for example, the CPU or the MPU executes a program, stored in an internal storage device, by using the RAM as a work area. Furthermore, the control unit 130 may be implemented by an integrated circuit, such as an ASIC or an FPGA. The control unit 130 includes a reception control unit 131, an identifying unit 132, a generating unit 133, and a transmission control unit 134, and it implements or executes functions and operations of information processing, which is described below. Here, the internal configuration of the control unit 130 is not limited to the configuration that is illustrated in FIG. 1, and it may be a different configuration as long as it is the configuration for conducting information processing that is described later.

The reception control unit 131 receives the management information from the base stations 50 via the communication unit 110 and the network N. The reception control unit 131 outputs the received management information to the identifying unit 132 and the generating unit 133.

Furthermore, as the management information in relation to the deemed GMDSS, the reception control unit 131 receives, for example, the management information that is transmitted from the certain mobile terminal 10 at an interval of equal to or more than a predetermined time period. Here, the predetermined time period may be for example 3 hours. This is because, in a case where, for example, the mobile terminal 10 transmits the management information at an interval of 6 hours, the reception control unit 131 allows for some margin for the time interval even if it is not strictly an interval of 6 hours. Furthermore, the reception control unit 131 may receive the management information in relation to the deemed GMDSS, which is transmitted from the mobile terminal 10 at an interval of less than a predetermined time period, or may discard it without receiving it. In some propagation states of radio waves, the reception control unit 131 receives the management information in relation to the deemed GMDSS, which is transmitted from the identical mobile terminal 10, from the base stations 50. The reception control unit 131 outputs the received management information in relation to the deemed GMDSS to the identifying unit 132.

When the identifying unit 132 receives input of the management information from the reception control unit 131, it identifies the identification information on the mobile terminal 10 from the received management information based on the message format 21. Here, as the identification information, the fishing vessel registration number for identifying the fishing vessel may be used, or the call sign, assigned to a wireless station of the mobile terminal 10, may be used. The identifying unit 132 relates the received management information and the identified identification information and outputs it to the generating unit 133 and the transmission control unit 134.

The generating unit 133 receives input of the management information from the reception control unit 131 and receives input of the identification information that is identified by the identifying unit 132. The generating unit 133 stores, in the tidal-current data storage unit 122, the direction and the magnitude of the tidal current for each fishing vessel, included in the management information, the positional information before and after movement, the transmission time of the management information, and the identification information on the mobile terminal 10. The generating unit 133 generates the tidal current information by mapping the direction and the magnitude of the tidal current for each fishing vessel and the positional information before and after movement within a predetermined range of transmission times on, for example, the marine chart of the corresponding ocean area so as to obtain the distribution of the tidal current. Here, the tidal current information may include data on seawater temperature, sea surface height, or the like, as well as the direction and the magnitude of the tidal current. The generating unit 133 outputs the generated tidal current information to the transmission control unit 134. Furthermore, as for the tidal current information, the marine chart may be prepared on the side of the mobile terminal 10 so that the transmitted data on the position, the direction, and the magnitude of the tidal current is mapped on the marine chart by the side of the mobile terminal 10 for presentation.

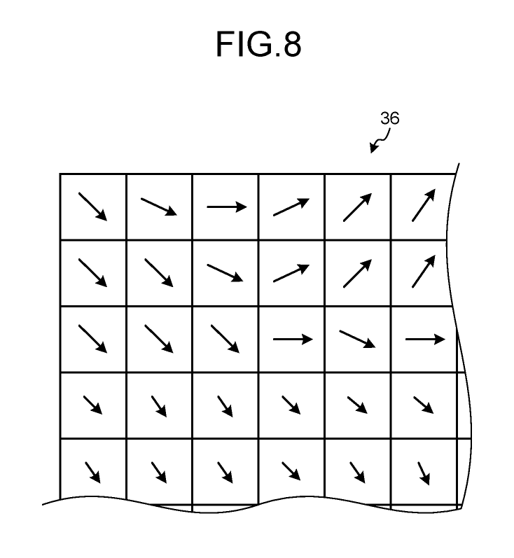

Here, an explanation is given of an example of presentation of the tidal current information. FIG. 8 is an explanatory diagram that illustrates an example of presentation of the tidal current information. As illustrated in FIG. 8, in the tidal current information, for example, the ocean area on a marine chart 36 is divided into cells with a predetermined size, the direction of the tidal current is indicated by an arrow on each cell, and the magnitude of the tidal current is indicated by using the length of the arrow. The direction of the tidal current is indicated by using, for example, 16 directions. In the tidal current information, for example, as other information, the seawater temperature or the sea surface height may be presented by changing the color, for example.

After the transmission control unit 134 receives input of the tidal current information from the generating unit 133, it transmits the tidal current information to the mobile terminals 10, which are provided in vessels, including fishing vessels, sailing on the corresponding ocean area, via the communication unit 110, the network N, and the base stations 50. Furthermore, the transmission control unit 134 may store the transmitted tidal current information as logs in the tidal-current data storage unit 122.

After the transmission control unit 134 receives input of the management information and the related identification information from the identifying unit 132, it refers to the management-information storage unit 121 and, based on the identification information, identifies the management body to which the mobile terminal 10 belongs. Specifically, based on the identification information, the transmission control unit 134 identifies the fishery radio association 70 to which the fishing vessel with the mobile terminal 10 installed therein belongs. The transmission control unit 134 transmits the management information to the terminal device 80 of the identified fishery radio association 70 via the communication unit 110 and the network N.

If the identification information in the management information, input from the identifying unit 132, is the same as the identification information in the management information that has been already transmitted to the terminal device 80 of the fishery radio association 70 within a predetermined time period, the transmission control unit 134 discards the input management information and identification information. Specifically, the transmission control unit 134 determines that the input management information and identification information are the second or subsequent pieces of management information among the ones that are received by the base stations 50 and does not transmit them to the terminal device 80 of the fishery radio association 70.

If part of the positional information, included in the management information, is coded, the transmission control unit 134 transmits the management information, in which the positional information is not decoded and part of them is still coded, to the terminal device 80 of the identified fishery radio association 70 via the communication unit 110 and the network N.

Furthermore, the transmission control unit 134 transmits the reception information, indicating that the management information, transmitted from the mobile terminal 10, has been received, to an undepicted terminal device of a person involved in the fishing vessel with the mobile terminal 10 installed therein via the communication unit 110 and the network N. For example, the transmission control unit 134 refers to the management-information storage unit 121, acquires the e-mail address of the person involved, and transmits the reception information as an e-mail. The reception information may include only the message that the management information has been received, or it may include other additional information, such as the positional information.

Furthermore, if the management information includes the information for identifying emergent information, the transmission control unit 134 immediately transmits the management information to an undepicted organization that handles the emergency information, e.g., Japan Coast Guard. Thus, the information processing device 100 is capable of promptly transmitting emergent information to the organization that can handle it.

Next, an explanation is given of an operation of the information processing system 1 according to the embodiment. In the following explanations, as an example of the operation of the information processing system 1, an explanation is given of a case where the management information, including the tidal current data, is received from the mobile terminals 10-1, 10-2, provided in the fishing vessels that are doing fishing in distant seas, and the tidal current information, including the distribution of the tidal current, is transmitted to the mobile terminals 10-1, 10-2. Furthermore, in the following explanations, as the operations of the mobile terminal 10-1 and the mobile terminal 10-2 are basically the same, the mobile terminal 10-1 is explained, and the explanation for the operation of the mobile terminal 10-2 is omitted.

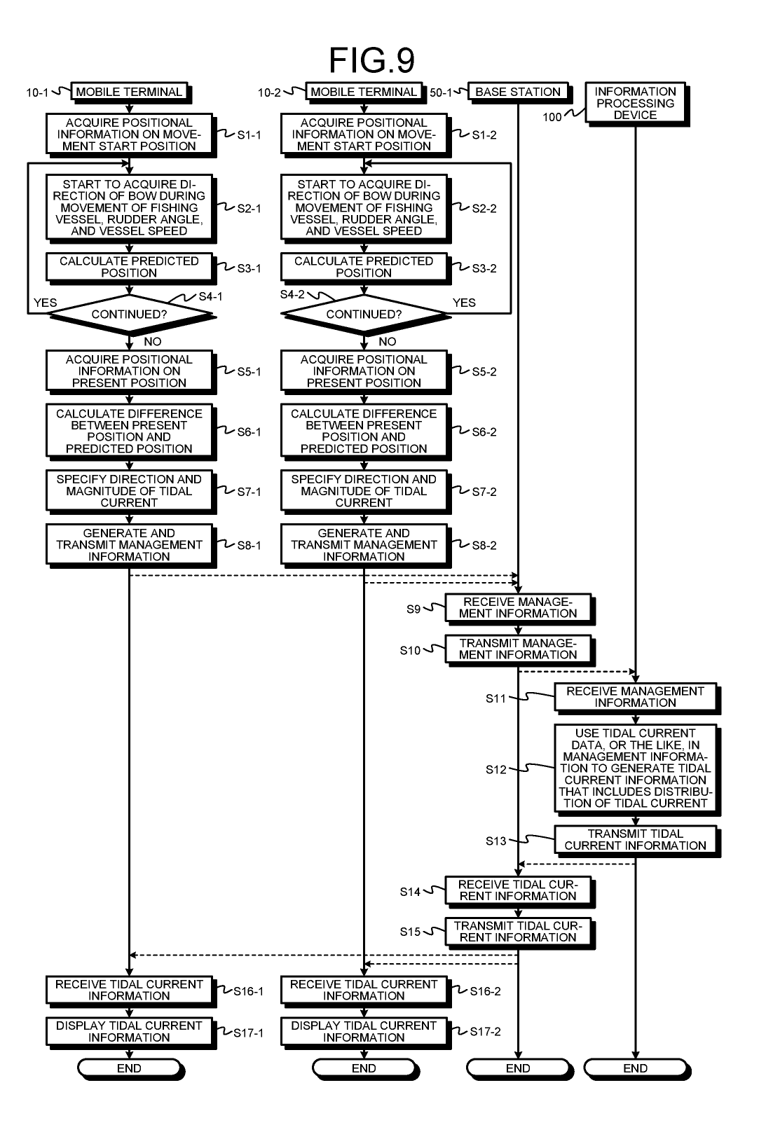

FIG. 9 is a sequence diagram that illustrates an example of the operation of the information processing system according to the embodiment. After the fishing vessel starts to move, the acquiring unit 15a of the mobile terminal 10-1, provided in the fishing vessel, outputs a request to continuously conduct positioning to the positioning unit 13. After the acquiring unit 15a receives input of the positional information, which corresponds to the positioning request, from the positioning unit 13, it acquires the first input positional information as the positional information on the movement start position (Step S1-1).

After the fishing vessel starts to move, the acquiring unit 15a starts to acquire the direction of the bow from an undepicted orientation sensor, gyrocompass, or the like. Furthermore, the acquiring unit 15a starts to acquire the rudder angle and the vessel speed based on the rotating speed of the engine from an undepicted navigation device of the fishing vessel (Step S2-1). The acquiring unit 15a outputs, to the calculating unit 15b, the acquired positional information on the movement start position and the direction of the bow, the rudder angle, and the vessel speed during movement of the fishing vessel, for which acquisition has been started. The acquiring unit 15a outputs the positional information on the movement start position to the specifying unit 15c. Furthermore, the acquiring unit 15a starts to output, to the specifying unit 15c, the positional information, which is acquired while the fishing vessel is being moved, as the current positional information.

After the calculating unit 15b receives input of the acquired positional information on the movement start position and the direction of the bow, the rudder angle, and the vessel speed during movement of the fishing vessel, for which acquisition has been started, it calculates the predicted position of the fishing vessel based on these pieces of information (Step S3-1).

The specifying unit 15c receives input of the current positional information from the acquiring unit 15a and receives input of the predicted position from the calculating unit 15b. The specifying unit 15c determines whether calculation of the predicted position is to be continued based on the current positional information and the prediction information (Step S4-1). If calculation of the predicted position is to be continued (Step S4-1: yes), the specifying unit 15c gives a command to continue it to the acquiring unit 15a and the calculating unit 15b and then returns to Step S2-1. If calculation of the predicted position is not to be continued (Step S4-1: no), the specifying unit 15c acquires the input current positional information as the positional information on the present position (Step S5-1).

The specifying unit 15c calculates the difference between the present position and the predicted position (Step S6-1). The specifying unit 15c specifies the direction and the magnitude of the tidal current based on the calculated difference (Step S7-1). The specifying unit 15c combines the present position and the positional information on the movement start position, input from the acquiring unit 15a, as the positional information before movement to obtain the positional information before and after movement. The specifying unit 15c generates the specified direction and magnitude of the tidal current and the positional information before and after movement as the tidal current data. The specifying unit 15c generates the management information that includes the tidal current data and the identification information that is previously set in the control unit 15. The specifying unit 15c transmits the generated management information to the base stations 50 via the communication unit 11 (Step S8-1).

The communication unit 51 of the base station 50-1 receives the radio waves that are transmitted from the mobile terminal 10. Specifically, the communication unit 51 receives the management information that is included in the received radio waves (Step S9). The communication unit 51 transmits the received management information to the information processing device 100 via the network N (Step S10).

The reception control unit 131 of the information processing device 100 receives the management information from the base station 50-1 via the communication unit 110 and the network N (Step S11). The reception control unit 131 outputs the received management information to the identifying unit 132 and the generating unit 133. After the identifying unit 132 receives input of the management information from the reception control unit 131, it identifies the identification information on the mobile terminal 10 from the received management information based on the message format 21.

The generating unit 133 receives input of the management information from the reception control unit 131 and receives input of the identified identification information from the identifying unit 132. The generating unit 133 stores, in the tidal-current data storage unit 122, the direction and the magnitude of the tidal current for each fishing vessel, included in the management information, the positional information before and after movement, the transmission time of the management information, and the identification information on the mobile terminal 10. Furthermore, the generating unit 133 uses the tidal current data, or the like, on each fishing vessel within a predetermined range of transmission times to, for example, conduct mapping on the marine chart of the corresponding ocean area and generate the tidal current information that includes the distribution of the tidal current (Step S12). The generating unit 133 outputs the generated tidal current information to the transmission control unit 134.

After the transmission control unit 134 receives input of the tidal current information from the generating unit 133, it transmits the tidal current information to the base stations 50 so as to transmit it to the mobile terminals 10 that are provided in the vessels, including fishing vessels, which sail on the corresponding ocean area (Step S13).

The communication unit 51 of the base station 50-1 receives the tidal current information, transmitted from the information processing device 100 via the network N (Step S14). The communication unit 51 transmits the tidal current information to the fishing vessel with the mobile terminal 10 installed therein, or the like, at a predetermined time and frequency in accordance with a predetermined time table (Step S15).

The control unit 15 of the mobile terminal 10-1 receives the tidal current information from the base station 50-1 via the communication unit 11 (Step S16-1). The control unit 15 maps the received tidal current information on the marine chart and causes the display operating unit 14 to display it (Step S17-1). Here, Step S1-2 to Step S17-2 of the mobile terminal 10-2 are the same as the corresponding Step S1-1 to Step S17-1 of the mobile terminal 10-1. In this manner, the information processing device 100 is capable of generating the distribution of the tidal current on the ocean area, in which each fishing vessel sails, based on the tidal current data that is collected from the mobile terminal 10, provided in each fishing vessel. Furthermore, the information processing device 100 is capable of providing the generated distribution of the tidal current as the tidal current information to a vessel which sails on the corresponding ocean area.

As described above, the information processing system 1 includes the mobile terminals 10; the base stations 50; and the information processing device 100. The mobile terminals 10 are provided in vessels, and they include the acquiring unit that acquires the positional information on the movement start position of a vessel and the direction of the bow, the rudder angle, and the vessel speed of the vessel during movement; and a calculating unit that calculates the predicted position of the vessel based on the positional information on the movement start position, the direction of the bow, the rudder angle, and the vessel speed. The mobile terminals 10 include a specifying unit that specifies the direction and the magnitude of the tidal current based on the difference between the current positional information on the vessel and the predicted position; and a communication unit that transmits, to the base stations 50, the management information that includes the specified direction and magnitude of the tidal current, the positional information before and after movement of the vessel, and the identification information on the mobile terminal 10. The base stations 50 include a communication unit that receives the management information, transmitted from the mobile terminal 10, and transmits it to the information processing device 100. The information processing device 100 includes the receiving unit that receives the management information from the base station 50, which has received the management information, among the base stations 50; and a generating unit that generates the tidal current information that includes the distribution of the tidal current on the ocean area, in which each vessel sails, based on the direction and the magnitude of the tidal current for each vessel, included in the received management information, the positional information before and after movement of each vessel, and the identification information on each of the mobile terminals 10. As a result, it is possible to generate the distribution information on the tidal current with high accuracy.

Furthermore, the information processing device 100 of the information processing system 1 transmits the generated tidal current information to the base stations 50, and the base stations 50 transmit the tidal current information to the mobile terminals 10. As a result, the tidal current information may be provided to vessels.

Furthermore, the information processing device 100 of the information processing system 1 identifies a vessel that is located in the ocean area, included in the generated tidal current information, generates the tidal current information for the mobile terminal 10, provided in the identified vessel, and transmits it to the base stations. As a result, the tidal current information may be provided to a vessel that sails on the ocean area for which the tidal current information is collected.

Furthermore, the mobile terminal 10, which is a movable terminal device, calculates the predicted position of a vessel based on the positional information on the movement start position of the vessel, the direction of the bow of the vessel during movement, the rudder angle, and the vessel speed, detects the arrival position at which the vessel arrives, and calculates the direction and the magnitude of the tidal current based on the difference between the arrival position and the calculated predicted position. As a result, it is possible to acquire the tidal current data based on sailing of the vessel.

Furthermore, as the vessel speed, the mobile terminal 10 uses the speed based on the rotating speed of the engine of the vessel or the speed that is measured by the vessel speed meter of the vessel. As a result, it is possible to predict the position based on the speed that is measured by the vessel.

Furthermore, although the vessel speed meter that measures the speed of a fishing vessel includes an electromagnetic or acoustic vessel speed meter according to the above-described embodiment, this is not a limitation. For example, other meters, such as a fluid-pressure type log, may be used to measure the vessel speed as long as the meter is capable of measuring movement relative to water.

Furthermore, although the parameters that are measured by the mobile terminal 10 include the direction of the bow, the rudder angle, and the vessel speed according to the above-described embodiment, these are not limitations. For example, the mobile terminal 10 may measure other marine phenomenon information, such as seawater temperature or salt concentration, or weather information, such as wind speed, weather, or rainfall amount, and may transmit these pieces of information to the base station 50 in such a manner that it is included in the management information. Thus, it is possible to acquire marine phenomenon and weather information on the ocean area in more details.

Furthermore, although the information processing device 100 transmits the reception information to the person involved in the fishing vessel with the mobile terminal 10 installed therein according to the above-described embodiment, this is not a limitation. For example, the information processing device 100 may additionally have a Web server function so that the Web page on the Internet presents the map, on which the positional information on each fishing vessel is plotted, and the person involved in the fishing vessel logs in the Web page so as to view the Web page. In this manner, the person involved in the fishing vessel sees the position of the fishing vessel, plotted on the map, thereby understanding the position of the fishing vessel more easily. Furthermore, the reception information may be transmitted to a person involved in a fishing vessel via a telephone, facsimile, or the like.

Furthermore, although an antenna, connected to the communication unit 51 of the base station 50, is connected to each wireless device according to the above-described embodiment, this is not a limitation. For example, a multi-band type antenna may be used, or an antenna tuner may be used. Furthermore, different frequencies may be used for transmission from the vessel to the shore and for transmission from the shore to the vessel. This causes easing of the conditions for the installation areas of antennas.

Furthermore, although PSK31 is used as an example of the digital modulation according to the above-described embodiment, this is not a limitation. For example, it is possible to use narrow-band digital modulations, which may be used in shortwave bands, such as RTTY (Radioteletype), packet communication, or SSTV. Thus, it is possible to conduct communications of a larger amount of data in a band with a higher frequency among the shortwave bands.

Furthermore, components of each unit illustrated do not always need to be physically configured as illustrated in the drawings. Specifically, specific forms of separation and combination of each unit are not limited to those depicted in the drawings, and a configuration may be such that all or some of them are functionally or physically separated or combined in an arbitrary unit depending on various types of loads or usage. For example, the above-described embodiment illustrates a case where the terminal device 80 is provided in the fishery radio association 70 together with the base station 50; however, the terminal device 80 may be provided in an area different from the base station 50 as long as it can perform communication with the information processing device 100.

Furthermore, all or any of various processing functions performed by each device may be implemented by a CPU (or a microcomputer such as an MPU or an MCU (Micro Controller Unit)). Furthermore, it is self-evident that all or any of the various processing functions may be implemented by programs analyzed and executed by a CPU (or a microcomputer such as an MPU or MCU) or by wired logic hardware.

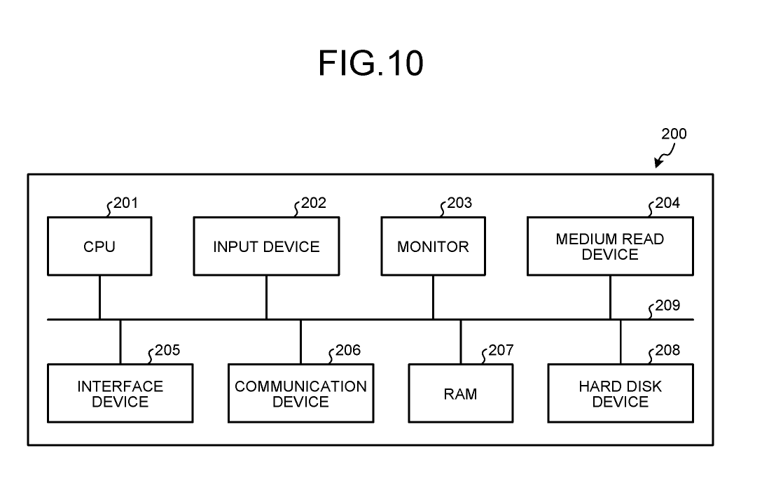

Furthermore, the various processes that have been described in the above embodiment may be performed if prepared programs are performed by a computer. Therefore, an explanation is given below of an example of a computer that executes a program that has the same functionality as that in the above-described embodiment. FIG. 10 is an explanatory diagram that illustrates an example of a computer that executes an information processing program.

As illustrated in FIG. 10, a computer 200 includes a CPU 201 that performs various calculation operations; an input device 202 that receives data input; and a monitor 203. Furthermore, the computer 200 includes a medium read device 204 that reads programs, or the like, from a storage medium; an interface device 205 for establishing connections with various devices; and a communication device 206 for establishing connections with other information processing devices, or the like, wired or wirelessly. Furthermore, the computer 200 includes a RAM 207 that temporarily stores various types of information; and a hard disk device 208. Furthermore, the CPU 201, the input device 202, the monitor 203, the medium read device 204, the interface device 205, the communication device 206, the RAM 207, and the hard disk device 208 are connected to a bus 209.

The hard disk device 208 stores the information processing programs that have the same functionalities as those of the processing units illustrated in FIG. 1, such as the reception control unit 131, the identifying unit 132, the generating unit 133, and the transmission control unit 134. Furthermore, the hard disk device 208 stores various types of data for implementing the management-information storage unit 121, the tidal-current data storage unit 122, and the information processing program. The input device 202 receives, for example, inputs of various types of information, such as operation information, from the administrator of the computer 200. The monitor 203 presents, for example, various screens to the administrator of the computer 200. The interface device 205 is connected to, for example, a printing device. For example, the communication device 206 has the same functionality as that of the communication unit 110, illustrated in FIG. 1, and it is connected to the network N so as to communicate various types of information, such as the management information, with the base station 50.

The CPU 201 reads each program, stored in the hard disk device 208, and loads it into the RAM 207 for execution, thereby performing various operations. Furthermore, these programs allow the computer 200 to function as the reception control unit 131, the identifying unit 132, the generating unit 133, and the transmission control unit 134, illustrated in FIG. 1.

Furthermore, the above-described information processing program does not always need to be stored in the hard disk device 208. For example, a program may be stored in a storage medium that is readable by the computer 200 and may be read by the computer 200 for execution. The storage medium readable by the computer 200 is equivalent to, for example, a portable recording medium, such as CD-ROM, DVD disk, or USB (Universal Serial Bus) memory, a semiconductor memory, such as flash memory, or a hard disk drive. Furthermore, the information processing program may be stored in a device that is connected to a public network, the Internet, a LAN, or the like, so that the information processing program is read from it by the computer 200 for execution.

It is possible to generate the distribution information on the tidal current with a higher accuracy.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
a plurality of movable terminal devices;
a plurality of base stations; and
an information processing device, wherein
the plurality of movable terminal devices are provided in vessels, and
the plurality of movable terminal devices include:
a first processor that executes a first process including:
acquiring positional information on a movement start position of the vessel and a direction of a bow, a rudder angle, and a vessel speed of the vessel during movement;
calculating a predicted position of the vessel in accordance with the positional information on the movement start position, the direction of the bow, the rudder angle, and the vessel speed;
specifying a direction and a magnitude of a tidal current in accordance with a difference between current positional information on the vessel and the predicted position; and
transmitting, to the plurality of base stations, management information that includes the direction and the magnitude of the tidal current specified, positional information before and after movement of the vessel, and identification information on the movable terminal device,
the plurality of base stations include a second processor that executes a second process including receiving the management information, transmitted from the movable terminal device, and transmitting the management information to the information processing device, and
the information processing device includes:
a third processor that executes a third process including:
receiving the management information from a base station, which has received the management information, among the plurality of base stations; and
generating tidal current information that includes a distribution of a tidal current on an ocean area where each of the vessels sails in accordance with a direction and a magnitude of a tidal current for each of the vessels, positional information before and after movement of each of the vessels, and identification information on each of the plurality of movable terminal devices, included in the management information received.

2. The information processing system according to claim 1, wherein
the information processing device transmits the tidal current information generated to the plurality of base stations, and
the plurality of base stations transmit the tidal current information to the movable terminal device.

3. The information processing system according to claim 1, wherein
the information processing device
identifies a vessel that is located on an ocean area, included in the tidal current information generated, and
generates the tidal current information for the movable terminal device, provided in the vessel identified, and transmits the tidal current information to the plurality of base stations.

4. An information processing method comprising:
calculating a predicted position of a vessel in accordance with positional information on a movement start position of the vessel and a direction of a bow, a rudder angle, and a vessel speed of the vessel during movement, by a processor; and
detecting an arrival position at which the vessel arrives and calculating a direction and a magnitude of a tidal current in accordance with a difference between the arrival position and the predicted position calculated, by the processor.

5. The information processing method according to claim 4, wherein the vessel speed is a speed based on a rotating speed of an engine of the vessel or a speed that is measured by a vessel speed meter of the vessel.

6. A non-transitory computer-readable recording medium storing an information processing program that causes a computer to execute a process comprising:
calculating a predicted position of a vessel in accordance with positional information on a movement start position of the vessel and a direction of a bow, a rudder angle, and a vessel speed of the vessel during movement; and
detecting an arrival position at which the vessel arrives and calculating a direction and a magnitude of a tidal current in accordance with a difference between the arrival position and the predicted position calculated.

7. A movable terminal device comprising:
a processor that executes a process including:
acquiring positional information on a movement start position of a vessel and a direction of a bow, a rudder angle, and a vessel speed of the vessel during movement;
calculating a predicted position of the vessel in accordance with the positional information on the movement start position, the direction of the bow, the rudder angle, and the vessel speed; and
specifying a direction and a magnitude of a tidal current in accordance with a difference between current positional information on the vessel and the predicted position.
